(19) United States
(12) Patent Application Publication
(10) Pub. No.: US 2009/0037403 A1
(43) Pub. Date: Feb. 5, 2009

(54) GENERALIZED LOCATION IDENTIFICATION

(75) Inventors: Joseph Joy, Bangalore (IN); Tanuja Joshi, Pune (IN); Vibhuti Sengar, Unnao (IN); Udayan Khurana, Hyderabad (IN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/831,939

(22) Filed: Jul. 31, 2007

(51) Int. Cl. G06F 7/06; G06F 17/30; G06F 3/14

(52) U.S. Cl. 707/5; 707/2; 707/4; 715/246; 707/E17.008; 707/E17.015; 707/E17.017

(57) ABSTRACT

A location identification system is described. In various embodiments, the location identification system identifies geographic location information in response to received search queries by processing geographic information to identify spatial or geometric regions, determining region intersection information that identifies spatial relationships between the geometric regions, and building an index of regions of constant attributes by associating intersecting geometric regions. In various embodiments, the location identification system can include a vector database wherein the vector database comprises geometric information including at least (a) spatial information geographically describing items and their locations and (b) textual attributes associated with the items or their locations, and an index of regions of constant attributes wherein the index associates textual attributes with items and their locations so that a proximity of two locations can be identified.

### BACKGROUND

People sometimes identify items based on where the items are located. As examples, people can identify a building, house, or other structure by a postal address; a printer or computing device in a large organization by its location within a specified building; an item in a warehouse by the shelf and location on the shelf on which it is stored; a machine in a large plant by its location within the plant; and so forth. However, the nomenclature for identification of locations often varies significantly. As examples, a postal address in the United States can be quite different from a postal address in another country and businesses may describe locations within a building or warehouse using different letters, numbers, or other designations. Searching for items based on their locations can be made difficult by these variations and lack of standardization.

Search engines have become popular tools for locating some types of information easily and quickly. When using a search engine, a user provides a search query including text or other information and the search engine provides matching results after performing a search. Search engines such as MICROSOFT LIVE SEARCH have made locating information very easy. Some search engines even let users locate businesses, homes, or other locations by providing postal addresses. However, ambiguous entry of locations in search queries can confuse search engines. As an example, searching for a particular street address while inadvertently providing an incorrect postal code (e.g., “zip code”) could result in no relevant or appropriate matches. Similarly, searching for a printer or machine by incorrectly specifying the location could also result in no relevant or appropriate matches.

Moreover, when there are multiple matches, the search engines may not have appropriate or sufficient contextual information to provide the results in a meaningful order. As an example, specifying multiple postal addresses or nearby locations may generate an assortment of results that are not meaningfully presented because they cannot be prioritized.

### SUMMARY

A location identification system is described. The location identification system can identify spatial location or entity information in response to received search queries by identifying geometric regions specified in a spatial information database, determining region intersection information that identifies spatial relationships between the geometric regions, building an index of regions of constant attributes and other indices by, analyzing the geometric and attribute data in the spatial database, and looking for interpretations that map multiple sub-sequences of the received search queries to multiple spatial entities. Spatial location information (also “spatial information”) can include geographic information, such as cities, counties, states, buildings, parks, structures, etc. A vector database can store the spatial information as a specification of entities composed of spatial primitives, such as points, lines, or polygons, each having associated textual or phonetic attributes. The index of regions of constant attributes can associate items with textual or phonetic attributes. The location identification system can generate a fuzzy text index based on text or phonetic information associated with the spatial information that the location identification system can employ with the index of regions of constant attributes when producing search results and employ the fuzzy text index to search for text or phonetic information that is similar to the received search query. Upon receiving a search query, the location identification system can split the input in the search query into a set of tokens. Each token can be a word of the search query that is separated from other words by some delimiter. The location identification system can then create a set of terms based on these tokens. The terms can be sub-sequences of the tokens from the search query. The location identification system can then employ the fuzzy text index to identify matches between query sub-sequences and attributes that are similar to that sub-sequence. The location identification system can then use the results from the fuzzy text index to explore the space of possible query interpretations to generate a set of candidate interpretations for the full query. The interpretations can then be used to lookup the index of regions of constant attributes to generate a set of search results based on the search query and provide a ranking for the search results. The search query can specify an address, a building name, a printer description and a building, floor or office, and so forth, and the location identification system can provide an appropriate set of search results. Each ranked result of the location identification system can include the list of spatial entities that match the query, as well as the spatial region that approximates the region covered by the query. The location identification system can provide search results to users in textual, spoken or graphical form, such as on a map. Thus, the location identification system can identify meaningful information based on a search query specifying general spatial location information, and thereby enable generalized location identification.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating an environment in which a location identification system can operate in some embodiments.

FIG. 2 is a block diagram illustrating components of the location identification system in various embodiments.

FIGS. 3-4 are block diagrams illustrating components of the location identification system and interactions among them in various embodiments.

FIG. 5 is a flow diagram illustrating an identify_matches routine invoked by the location identification system in some embodiments.

FIG. 6 is a flow diagram illustrating a find_interpretations routine invoked by the location identification system in some embodiments.

FIG. 7 is an image illustrating selection of a focus in some embodiments.

### DETAILED DESCRIPTION

A location identification system is described. In various embodiments, the location identification system identifies spatial location or entity information in response to received search queries by identifying geometric regions specified in a spatial information database, determining region intersection information that identifies spatial relationships between the geometric regions, building an index of regions of constant attributes and other indices by analyzing corresponding geometric and attribute information, and looking for interpretations that map multiple sub-sequences of the received result queries to multiple spatial entities. The system employs a vector database that can store the spatial information as a specification of spatial entities having spatial primitives, such as points, lines, or polygons, each having associated textual or phonetic attributes. As an example, the spatial information can include buildings, roads, parks, monuments, houses, and the like, and their associated street names, building names, types of businesses, and so forth. The location identification system can pre-process the spatial information stored in the vector database and can generate an index or multiple indices that the location identification system employs during the search process. As an example the location identification system can identify spatial relationships (e.g., intersection or containment) between the geometric regions, and can build an index of regions of constant attributes by associating intersecting geometric regions with a list of their textual or phonetic attributes.

The location identification system can employ a spatial footprint index to identify spatial locations corresponding to an attribute from the vector database. The location identification system can also generate a fuzzy text index based on text or phonetic information associated with the spatial information. This fuzzy index can be employed to search for text or phonetic information that is similar to the received search query. The fuzzy text index maps input tokens to spatial data entity attribute values. The input tokens can be text or phonetic information extracted from non-text queries such as voice queries. As a result, the location identification system can locate information even when the search query includes misspelled words, mispronounced words, incorrect punctuation or numbers, or when the user transliterates words from another language. The location identification system can provide search results to users in textual, audible or graphical form, such as on a map. Upon receiving a search query, the location identification system can split the text or phonetic symbols in the search query into a set of tokens. Each token is a word that is separated from other words by some delimiter, such as white space, commas, semicolons, silence (if speech) and so forth. As an example, if a user enters “Marymoor park, Radmond” as a search query, the tokens can be “Marymoor,” “park,” and “Radmond.” The location identification system then creates a set of terms based on these tokens. The terms can be every sub-sequence of the tokens in the search query. As an example, the terms for the search query in the example provided above can be “Marymoor,” “park,” “Radmond,” “Marymoor park,” “Marymoor Radmond,” and “park Radmond.” The location identification system can then employ the fuzzy text index to identify similar terms the stored spatial information. As an example, the fuzzy text index may specify that “Radmond” is similar to “Redmond.” The location identification system can then correlate the results from the fuzzy text index and the index of spatial footprints to generate a list of approximate match records (AMRs). Each AMR can be a mapping from a query sub-sequence to an attribute from the spatial information and its associated spatial footprint. The location identification system can then explore many possible combinations of AMRs by generating multiple interpretations of the query. Each interpretation can be correlated with the index of regions of constant attributes to generate a set of search results based on a search query and provide a ranking for the search results. As an example, the location identification system can base the ranking on the amount of spatial overlap of the terms. The search query can specify an address, a building name, a printer description and a building, floor or office, and so forth, and the location identification system can provide an appropriate set of search results. Thus, the location identification system can identify meaningful information based on a search query specifying general spatial location information, and thereby enable generalized location identification.

In some embodiments, the location identification system can receive a search query in a script of one natural language (e.g., the Devanagari script of the Hindi language) and locate information based on a transliteration of that script into a different script of another natural language (e.g., the Latin script of the English language). As an example, when a user does not know the spelling of a location in English, the user can identify the location in a search query using the script of a language with which the user is more familiar. The location identification system can detect the script type and transliterate the search query before conducting a search.

In some embodiments, the location identification system can receive input in the form of non-text sources, such as a digitally sampled voice. In such a case, conventional automatic speech recognition techniques can be applied to process voice input into the form of one or more phonemic tokens and the location identification system can use fuzzy lookup techniques to map these phonemic tokens to a list of approximately matching attribute values.

In some embodiments the spatial data can constitute three dimensional (3D) data, e.g., the parts layout of a complex machine, such as an airliner.

In some embodiments, the location identification system searches of terms computed from a search query. In these embodiments, the location identification system can first look up individual terms in the fuzzy text index and identify scores for each result. Some considerations for assigning scores can be textual or phonetic similarity between the query term and the matched attribute or the relative importance of the matched attribute. The terms with the highest scores can then be combined to identify a coherent interpretation of the query that identifies a region as a possible result. As an example, out of six additional terms generated from the sample query “Marymoor park Radmond” (Marymoor, park, Radmond, Marymoor park, Marymoor Radmond, park Radmond), the term “Marymoor park” will have the highest textual similarity score with the text attribute because it is the name of a park in Redmond, Wash., USA, “Marymoor park” and because the term and the name are identical. The other terms “park Radmond” and “Radmond” could have lower scores because there may be items in the vector database with attributes that are only similar to “Radmond” or “park Radmond”.

In various embodiments, the location identification system can treat scores produced during searching differently based on the search query. As an example, the location identification system may treat match results for a transliterated token with less weight than the match for an original word that was supplied with the search query.

In some embodiments, the location identification system provides a multilevel system. As an example, each level can be handled by one or more servers. Alternatively, several levels can be handled by one server. Each level may employ portions of a hierarchically divided set of vector data. As an example, one level may employ data that is relatively unique or globally important, such as countries, cities, landmarks, postal code boundaries, geopolitical boundaries, unique names, and so forth. When the location identification system receives a query, it may first send the search query to the server handling the relatively unique or important data before sending the search query to other servers handling more detailed or complete data for smaller regions. In various embodiments, the search results provided by these servers can be provided to the user or combined to create additional search queries to be provided to some of the servers. In some embodiments the entire system can reside on a single device, such as a server, a workstation, a laptop computer, a handheld computer, or any other computing device or a mobile device.

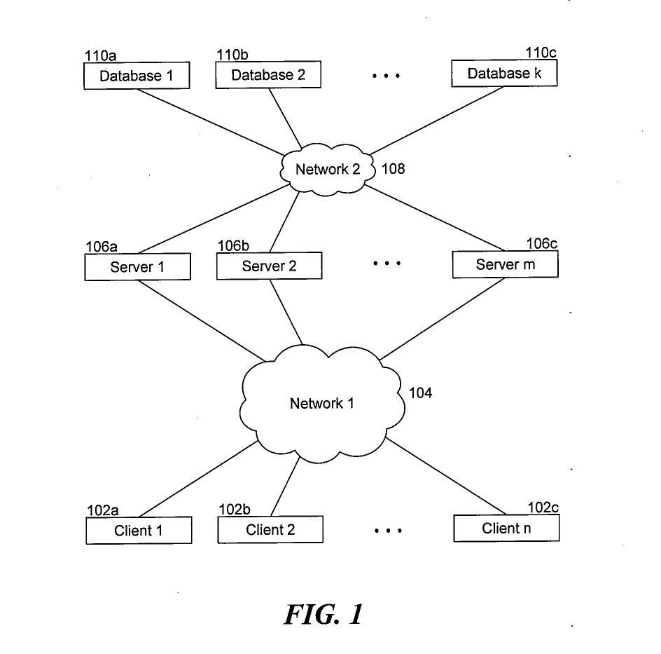

The location identification system will now be described with reference to the Figures. FIG. 1 is a block diagram illustrating an environment in which a location identification system can operate in some embodiments. The environment can include one or more client computing devices, such as client computing devices 102a, 102b, and 102c. A user can provide a search query to the location identification system at one of the client computing devices. Upon receiving a query, a client computing device may send the search query to a server via a network 104, such as an intranet, the Internet, or a cellular telephone network. The network may connect to multiple servers, such as servers 106a, 106b, and 106c. The servers may provide different services, or multiple servers may provide services associated with the location identification system. As an example, multiple servers may employ partitioned or common data when providing services. The servers may connect via a network 108 to one or more databases, such as databases 110a, 110b, and 110c. The network 108 can be an intranet or the Internet. The databases 110a-110c can store data associated with the location identification system. In various embodiments, the stored data may be duplicated or partitioned across the databases. The clients, servers, and databases can be various types of computing devices, such as general purpose or special purpose computing devices. Moreover, the network may comprise additional computing devices that are not illustrated in FIG. 1.

The computing devices on which the object location identification system operates may include one or more central processing units, memory, input devices (e.g., keyboard and pointing devices), output devices (e.g., display devices), storage devices (e.g., disk drives), and network devices (e.g., network interfaces). The memory and storage devices are computer-readable media that may store instructions that implement the object location identification system. In addition, the data structures and message structures may be stored or transmitted via a data transmission medium, such as a signal on a communications link. Various communications links may be employed, such as the Internet, a local area network, a wide area network, or a point-to-point dial-up connection.

The object location identification system may use various computing systems or devices, including personal computers, server computers, hand-held or laptop devices, multiprocessor systems, microprocessor-based systems, programmable consumer electronics, electronic game consoles, network PCs, minicomputers, mainframe computers, distributed computing environments that include any of the above systems or devices, and the like. The object location identification system may also provide its services to various computing systems, such as personal computers, cell phones, personal digital assistants, consumer electronics, home automation devices, and so on.

The object location identification system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

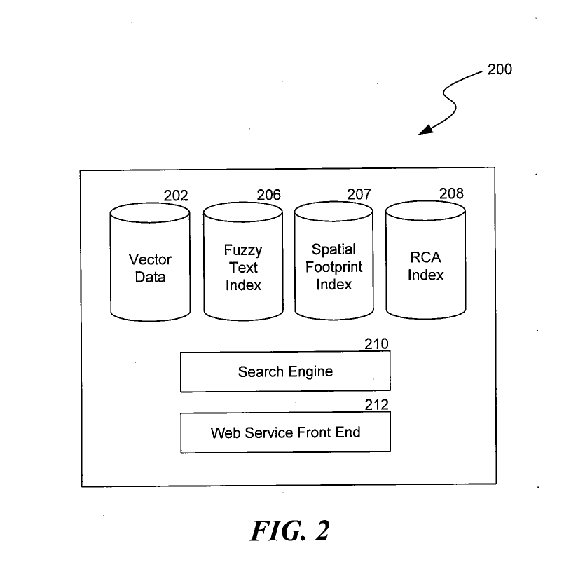

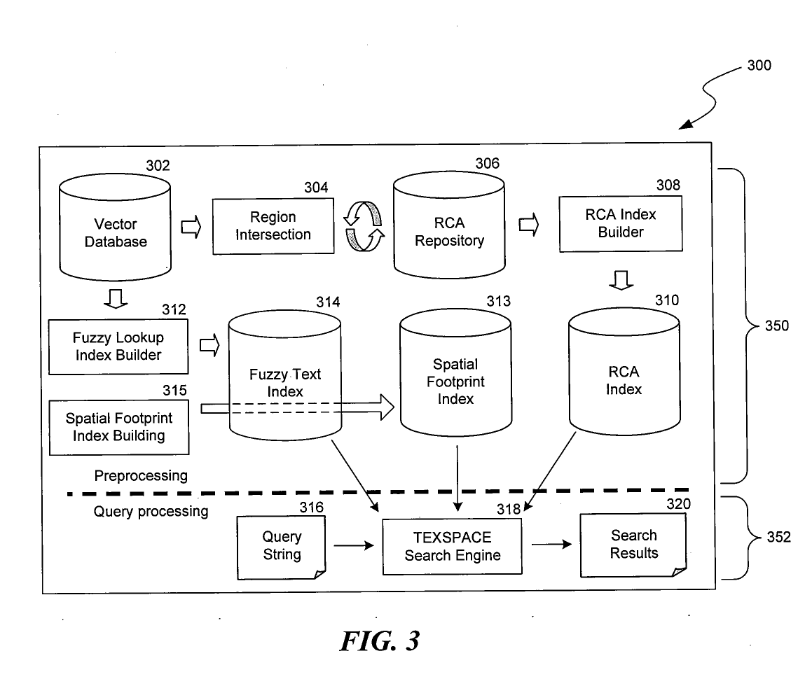

FIG. 2 is a block diagram illustrating components of the location identification system in various embodiments. A server computing device 200 of the location identification system can include a vector database 202, fuzzy text index 206, a spatial footprint index 207, and a region of constant attributes (“RCA”) index 208. The vector database 202 stores spatial location information, such as information associated with entities, such as streets, buildings, monuments, and so forth, including names and/or properties associated with these entities. The fuzzy text index 206 stores alternate forms of the names or their phonetic representations, such as pronunciation-based or phonetic-based information. The index can relate these alternate forms with entries in the vector database. The spatial footprint index 207 can contain attribute footprints, which can be an approximate representation of the union of the geometries of all the entities that share the attribute (e.g., the union of the geometries of all cities named “Redmond” or all the areas labeled “park”). The approximate representation can be of a form that enables fast spatial intersection operations. The RCA index relates spatial locations, such as based on their spatial relationship. As an example, it may relate intersecting spatial areas or collocated items. The index can point to entries in the vector database. These databases and indices will be described in further detail below in relation to FIG. 3. The server computing device 200 can also include a search engine 210 and a Web service front end 212. The search engine can receive a search query and employ the vector database, fuzzy text index, spatial footprint index, RCA index, and other components and algorithms to identify spatial locations or items. The search engine can rank search results or employ in its search various heuristics, such as based on edit distance or spatial coherence. When using edit distance, the location identification system can analyze word proximity. As an example, the location identification system can determine that “Radmond” is closer to “Redmond” than “Radley.” When using spatial coherence, the location identification system can analyze spatial information. As an example, the location identification system may determine that given a search query “Marymoor Park Radmond”, the “Marymoor Park” in Redmond, Wash., USA, is spatially coherent with Redmond, Wash., USA (one of the top fuzzy matches for term “Radmond”) than “Radley” (another possible fuzzy match for “Radmond”) since the geometries of the entries “Marymoor Park” and “Redmond” from the vector database have spatial overlap while the geometries of the entries “Marymoor Park” and “Radley” from the vector database do not.

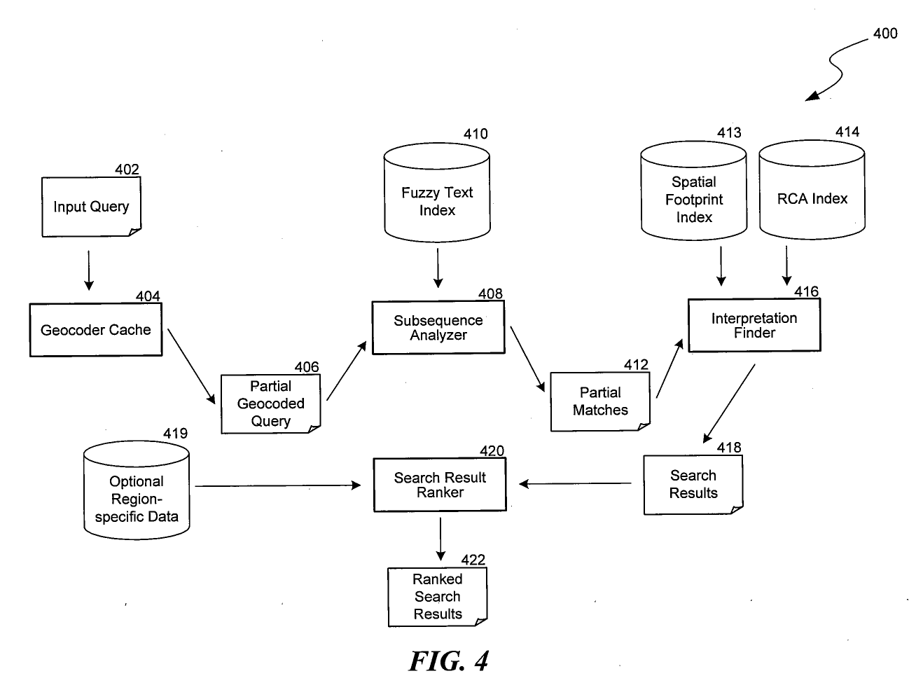

FIGS. 3-4 are block diagrams illustrating components of the location identification system and interactions among them in various embodiments. According to FIG. 3, a server computing device 300 has a preprocessing phase 350 and a query processing phase 352. During the preprocessing phase, the location identification system generates a fuzzy text index 314, associated spatial footprint index 313 and an RCA index 310 based on the vector data stored in a vector database 302. During the query processing phase, a search engine 318 receives a query string 316 and produces search results 320.

The vector database is the underlying database of spatial information that includes spatial primitives, such as points, lines, and polygons, each having textual or phonetic attributes (e.g., name, type) or other attributes. The vector database can include postal address information, or other location information corresponding to various items. In some embodiments, spatial information (e.g., geographic information) in the vector database is optional and relationships between items can be relational or “topological,” such as information about the relative proximity or containment relationships between items. As an example, the vector database may specify that some resources are available in rooms within buildings within a large complex, but not provide the spatial coordinates of these items, rooms, or buildings.

Each entry in the vector database can represent a physical item that has geometry and textual or phonetic attributes associated with it. As an example, these items can be roads, postal code regions, localities, state boundaries, counties, landmarks, facilities (e.g., hospitals, schools, or shopping centers), and so forth. Each item can be represented by one or more contiguous shapes and each shape can be a point, a line, or a polygon. The location identification system can employ computational geometry techniques to find geometric intersections between the shapes, and can generate compound spatial regions that correspond to geometric intersections between these regions identified by the geometric intersections. The intersection regions may have constant textual or phonetic attributes of the corresponding intersecting items and are thus termed regions of constant attributes. If other items have shapes that intersect this region, the intersection will create additional regions of constant attributes. The set of textual or phonetic attributes of the compound spatial regions identifies the items. As an example, an intersection of two roads, Road A and Road B, (which can be represented as “polylines” or multiple line segments) is the shape of a type point, and is defined to be a “Level 1” compound region having attributes (Road A, Road B). A Region Intersection component 304 builds an RCA repository 306 iteratively to compute higher order compound regions in this manner. The Region Intersection component also identifies and stores containment relationships between the items, aliases for names, and various metadata such as areas, frequency of occurrences of names, and so forth.

An RCA Index Builder component 308 builds the RCA index 310. The RCA Index supports efficient lookup of multiple items in the RCA repository 306 for a given set of attribute names. The names may not uniquely identify an item and can even contain names that are incompatible. The index can provide a list of items ranked by decreasing proximity of matches. As an example, the proximity can be defined as a function of the number of attributes that match and weights of attributes. The proximity function can be different depending on the type of vector data.

The RCA index can be stored as a hierarchical index. The index can include multiple hashtables arranged in a structure of a multilevel tree in which each internal node of the tree is a hashtable and external nodes store pointers to actual spatial item information in the RCA repository. Based on the spatial name at a particular level of the tree, each internal node hashtable redirects the search to a more specific sub-tree, and terminates at a leaf node that stores a pointer to information corresponding to the spatial location being searched. The location identification system can take various measures to reduce memory requirements of the large index. As an example, the location identification system can read hash tables on demand from disk so that only used hashtables are in memory at a given time.

A Fuzzy Lookup Index Builder component 312 builds the fuzzy text index 314. The location identification system can employ various conventional fuzzy lookup index builders. The Fuzzy Lookup Index Builder component creates a table of all unique textual or phonetic attributes from the RCA repository (and/or the vector database) and builds an error tolerant index based on these unique textual or phonetic attributes. The Fuzzy Lookup Index Builder can also extract the phonetic representation of the textual or phonetic attributes and store these representations in an additional index that can be during lookup time by providing transliterated query terms.

A Spatial Footprint Index Builder component 315 builds the spatial footprint index 313. Each spatial footprint in the index is a spatial representation of all the geometric shapes that share a particular textual or phonetic attribute. The location identification system can employ various techniques for representing spatial footprints that facilitate fast spatial intersection during query time. For example, geometric shapes can be represented by linear quadtrees or linear bintrees. Linear quadtrees and linear bintrees are described in Gargantini I., An Effective Way to Represent Quadtrees. Communications of the ACM, 1982, which is incorporated herein by reference.

When the search engine 318 receives the query string 316, it can perform multiple lookups using the fuzzy text index 314. Using the fuzzy text index, the search engine can locate several items that are textually or phonetically similar to the sub-sequences of the received query string (referred to as input terms) and can assign a score to the query sub-sequence to attribute name match results, such as based on the textual or phonetic similarity. In addition, the search engine may also search the additional phonetic index by providing a transliterated or abstracted version of the query sub-sequence. This improves the error tolerability of the system and especially helps when receiving a query string (or portion of a query string) in a script of a different natural language than used by the textual or phonetic attributes in the vector database. In some embodiments, the search engine may give more or less weight to matches found using the phonetic representations. As an example, when phonetic representations are imprecise, the search engine may give less weight.

According to FIG. 4, a server computing device 400 receives a query string 402, and produces ranked search results 422. To produce the search results, the location identification system can employ a geocoder cache component 404. The geocoder cache component determines whether any frequently occurring sub-sequences are present in the query string and retrieves cached matching attributes, if any, for those sub-sequences. It then provides this partial information 406, along with the unmatched terms in the query string, to a sub-sequence analyzer component 408. The sub-sequence analyzer identifies possible textual or phonetic attributes that match with the unmatched terms from the query string by using a Fuzzy Text Index 410 to produce a set of partial matches (also referred to as Approximate Match Records, or AMRs) 412. Each AMR matches a query sub-sequence to (1) a textual or phonetic attribute and (2) its associated spatial footprint and score, which can represent the textual or phonetic proximity between the sub-sequence and the matching attribute. The query string can produce many possible sub-sequences, and each sub-sequence in turn can produce multiple AMRs representing possible attribute matches. The location identification system can then provide the set of ranked textual or phonetic attributes to an Interpretation Finder component 416 component that assembles interpretations from one or more AMRs. Each interpretation is a mapping from one or more sub-sequences to an identified set of entities in spatial database. The Interpretation Finder component can apply various search techniques (e.g., depth first search), and can employ various heuristics (e.g., guided search based on spatial overlap of matched attribute footprints from the Spatial Footprint Index 413) to make the search for interpretations more efficient. The Interpretation Finder component can generate one or more interpretations, which form the search results 418. The Interpretation Finder component can employ an RCA index 414 to identify the specific spatial entities that make up the interpretation. The possible search results 418 are then provided to a Search Result Ranker component 420 for ranking and grouping to generate the ranked search results 422. The Search Result Ranker 420 can make use of optional Region-Specific Data 419, such as plot number ranges or other domain-specific information to increase the accuracy of the ranking and to increase the precision of the found regions.

The sub-sequence analyzer component 408 identifies terms in the query string that match textual or phonetic attributes of spatial data entities in the spatial vector database 302. The sub-sequence analyzer generates tokens from the query string by tokenizing the query based on delimiters such as spaces and commas. It then groups the tokens to form terms of varying length. These terms are then looked up in the Fuzzy Text Index to identify possible matching textual or phonetic attributes. The location identification system may then further process textual or phonetic attributes with a Fuzzy Lookup score above a specified threshold. To support cross-lingual search and to improve error tolerance, the query analyzer can also look up the abstracted versions of the terms in the abstracted Fuzzy Text Index to identify a collection of textual or phonetic attributes and collect those having a score higher than the threshold. Terms with overlapping text or phonemes (e.g., when a word is common to both the terms) are considered to be incompatible and are not considered to be part of a single interpretation. The sub-sequence analyzer can then rank the textual or phonetic names according to the Fuzzy Lookup score and provides a specified number of these ranked textual or phonetic attributes along with the associated metadata information such a reference of the attributes spatial footprints, in the form of a list of Approximate Match Records (AMRs) to the Interpretation Finder component. Each AMR can contain a sub-sequence from the original query, its matching attribute, and associated metadata such as spatial footprints and relevance score.

The Interpretation Finder component finds subsets of AMRs that are compatible in both text/phonetic and space domain. To do so, it uses the text/phonetic compatibility vector computed by the sub-sequence analyzer and uses the spatial footprint data structures found in the metadata with the textual or phonetic attributes to determine spatial overlap. It also keeps track of previous compatibility checks to avoid repeated calculations.

To incrementally build subsets of compatible approximate match records (AMRs), the Interpretation Finder component can apply one of several heuristic guided search techniques. One such technique is guided depth first search, which is described as follows. The Interpretation Finder selects the AMR with the most relevant (e.g., based on a Fuzzy Lookup score) textual or phonetic attribute as an “anchor” AMR and adds other AMRs compatible with the anchor AMR to an unincorporated AMR list in order of decreasing relevance. The Interpretation Finder component then adds other AMRs from the previous list that are also compatible with all previously selected anchors, and thereby builds up a partial interpretation list having compatible AMRs. The Result Enumerator repeats this process until there are no more items to be added to the current partial interpretation list. The list of compatible AMRs that the Interpretation Finder selects iteratively makes up one possible result for the search. To enumerate more possible results, the Interpretation Finder component may then backtrack and consider the next textual or phonetic attribute from the most recent unincorporated AMR list as the anchor element and can repeat these steps. Using this process, the Interpretation Finder component collects a “bag” of possible results, each having a set of compatible AMRs that represent a mapping from a sub-sequence of the query to attributes from the spatial vector database.

The selection of anchor textual/phonetic attributes has a large impact on the subset quality in terms of cardinality and relevance to the user as well as the time taken in the enumeration. The Interpretation Finder component may also keep track of the state of partial compatible subsets discovered during enumeration to reduce re-computation of compatible subsets.

Because the spatial overlap check using attribute spatial footprints can be approximate, and because the final interpretation also consists of the entities that make up the interpretation, the Interpretation Finder component next validates the possible results by looking in the RCA index. Because the lookup in the RCA index can be time-consuming, the Interpretation Finder component can employ heuristics (e.g., to look up larger subset first) so that only a few subsets are looked up. Valid textual or phonetic attribute subsets along with the spatial entities (referred to as Search Results) identified in this step may then be provided to the Search Result Ranker component.

The Search Result Ranker component ranks the search results using a ranking algorithm. As an example, it computes a combined score for individual results based on the Fuzzy Lookup score of each textual or phonetic attribute in the subset, uniqueness of the textual or phonetic attribute in the RCA repository, and the number of textual or phonetic attributes in the subset. The Search Result Ranker can employ relatively sophisticated domain-specific ranking techniques because the results can consist of a small number (e.g., ten to twenty) of interpretations, and each interpretation already contains a list of specific entity references so no further entity search is required. In To keep the core system generic, any such domain-specific ranking can be delegated to an external component. For example, the system can employ existing plot number interpolation techniques by extracting the plot number from unmatched portions of the search query, and use this plot number to further refine the ranking as well as further refine the geometric region of the found result.

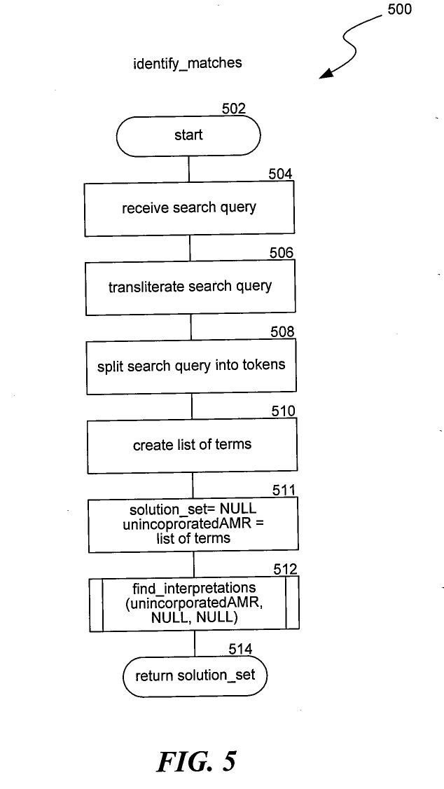

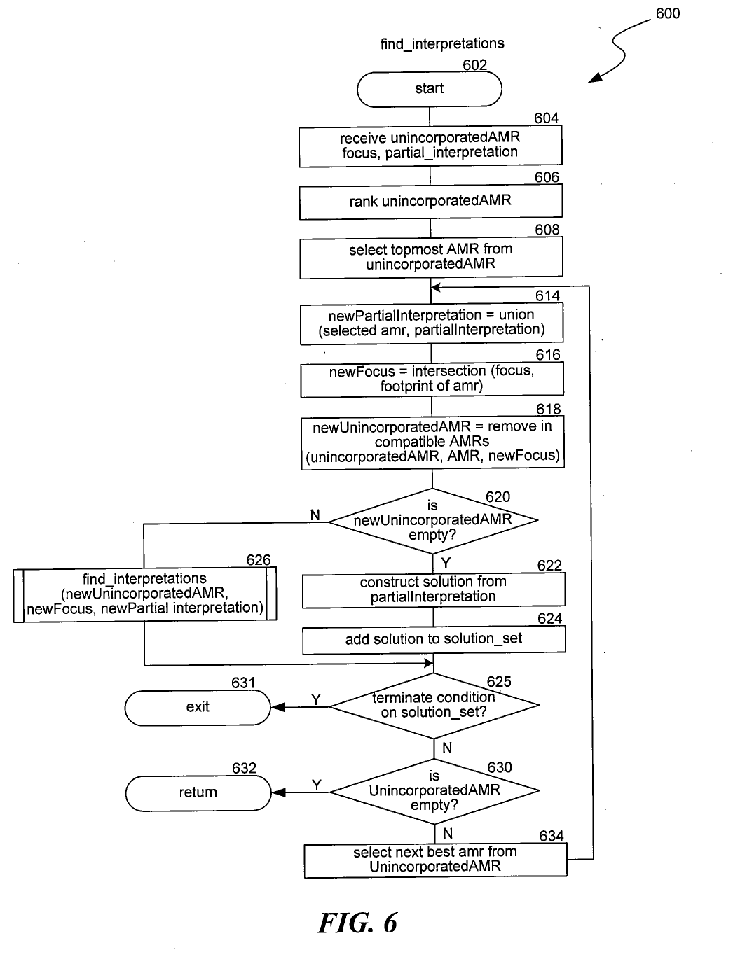

FIG. 5 is a flow diagram illustrating an identify_matches routine 500 invoked by the location identification system in some embodiments. The routine 500 identifies matches (e.g., locates search results) for a search query. The routine begins at block 502. At block 504, the routine receives a search query. At block 506, the routine can transliterate the search query, such as when the search query is received using a script of a natural language that is different from a script of a natural language that is associated with stored information that will be searched. At block 508, the routine splits the received search query into tokens. At block 510, the routine creates a list of terms based on the tokens. When a search query has N words, there are N*(N+1)/2 terms. At block 511, the routine creates a NULL set as a solution set (“solution_set”) and sets a variable “unincorporated AMR” to the created list of terms. At block 512, the routine invokes a match_terms subroutine to provide search results based on the created terms. The routine may provide a list of the terms to the match_terms subroutine. The match_terms subroutine is described in further detail immediately below in relation to FIG. 6. The routine returns the matches (e.g., search results) at block 514.

Those skilled in the art will appreciate that the logic illustrated in FIG. 5 and described above, and in each of the flow diagrams discussed below, may be altered in a variety of ways. For example, the order of the logic may be rearranged, substeps may be performed in parallel, illustrated logic may be omitted, other logic may be included, etc.

FIG. 6 is a flow diagram illustrating a find-interpretations routine 600 invoked by the location identification system in some embodiments. The routine 600 locates search results for a list of terms. The routine performs a heuristic-guided depth first search over the space of possible interpretations. The routine constructs partial interpretations of the received query by choosing terms one by one from a set of unincorporated AMRs and adding them to partially constructed interpretations. As it picks additional terms, the routine computes spatial intersections of the footprints of all the chosen AMRs and filters out remaining AMRs whose footprints do not lie within the intersection or whose sub-sequences contain overlaps with the chosen AMRs. The routine can return a set of interpretations and corresponding candidate locations. The routine begins at block 602.

At block 604, the routine receives unincorporated AMRs representing possible AMRs that could be added to the partial interpretation, the focus of the current partial interpretation representing a geometric region that defines the scope further exploration, and a partial interpretation representing the current partially constructed interpretation. The routine may also maintain a global solution set that contains complete interpretations of the query.

The algorithm may initially start with (1) an empty partial interpretation, (2) a set of unincorporated AMRs formed by the complete output of the sub-sequence-mapping component (i.e., the set of AMRs that result from identifying possible sub-sequence-attribute matches), (3) an empty solution set, and (4) the initial area of focus. The initial focus can be the whole world or a smaller region identified by the component that invokes the routine. Specifying a smaller region as initial focus is a way to restrict the overall spatial scope of the query to a particular region.

At block 606, the routine ranks (e.g., orders) the input set of unincorporated AMRs in order of decreasing “promise.” As an example, the routine can sort AMRs in order of decreasing fuzzy-text match score, so that AMRs with attributes that match closely with input terms are earlier in the list. Other orderings are also possible.

In the loop between blocks 608-634, the routine adds each of the AMRs in the unincorporated AMR set to the current partial interpretation. At block 608, the routine selects an AMR. For each AMR in the unincorporated set, the routine computes the following: (a) a new partial interpretation that is the union of amr and the current partial interpretation; (b) a new focus that is the spatial intersection of amr's footprint and the current focus; and (c) a new unincorporated AMR list that filters out incompatible AMRs.

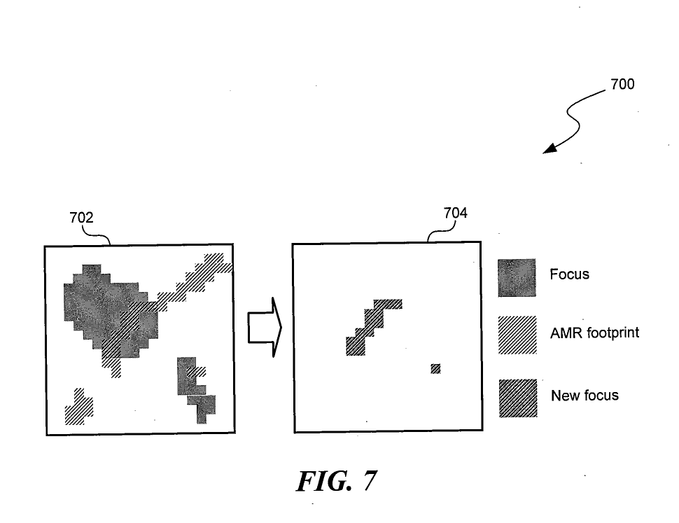

At block 614, the routine sets a variable newPartialInterpretation to the union of the selected AMR and the existing partialInterpretation. At block 616, the routine sets a variable newFocus to the intersection of the existing focus with the footprint of the selected AMR. The intersection operation typically results in a narrowing of the focus, as is illustrated in FIG. 7. According to FIG. 7, a focus change 700 occurs between blocks 702 and 704. These blocks show an original focus area, an AMR footprint, and a new focus area. The new focus area is the intersection between the original focus area and the AMR footprint.

Returning now to FIG. 6, at block 618, the routine sets a variable newUnincorporatedAMR by removing incompatible AMRs. The routine invokes a RemoveIncompatibleAMR routine to remove the incompatible AMRs.

The RemoveIncompatibleAMR routine takes as input a list of unincorporated AMRs and returns a smaller list that is created by removing all AMRs that are either textually/phonetically incompatible or spatially incompatible with the new focus set of AMRs. AMRs are considered spatially incompatible if their associated footprints do not overlap in space. Two AMRs are considered textually/phonetically incompatible if their matched sub-sequences contain the same word (or words) from the input query. For example, given a query “Marymoor Park Radmond,” AMRs derived from “Marymoor Park” are incompatible with those derived from “Park Radmond”.

At decision block 620, the routine determines whether the unincorporated AMR set is empty. If the unincorporated AMRs set is empty, it means the partial interpretation cannot be expanded further, in turn implying that a viable interpretation has been discovered. If the set is empty, the routine continues at block 622. Otherwise, the routine continues at block 626.

The routine then obtains the entities associated with this interpretation by querying the spatial index, specifying the matched attributes and final focus. The routine then adds this new interpretation to the solution set, and the routine terminates the current branch of the depth-first search. At block 622, the routine constructs a solution from the partial interpretation. At block 626, the routine invokes itself recursively. In other embodiments, recursion may be avoided, such as by using a loop.

The operation continues until the search ends or until an early termination condition is met at decision block 625, in which case the overall find_interpretations process exits at block 631 to end recursion. Various heuristics can be used for early termination, e.g., that take into account the number and quality of found solutions.

If at decision block 630 all AMRs have been processed, the recursive routine returns at block 632 to continue recursion. Otherwise, the routine continues at block 634. At block 634, the routine selects the next best AMR from the list of unincorporated AMRs and repeats the process starting at block 614.

An attribute's footprint approximately represents the geometries of all entities that match the attribute, and hence a footprint can represent a large number of discontiguous geometries. Therefore, efficient computation of this intersection is important to the overall efficiency of the algorithm. There are several techniques available to those skilled in the art for fast intersection of approximate representations of shapes in the form of AMR footprints which can be precomputed and stored in the spatial footprint index. For example, linear quadtrees, or their generalization to linear bintrees may be used as the representation of spatial footprints, and are described in Gargantini I., An Effective Way to Represent Quadtrees. Communications of the ACM, 1982, which is incorporated herein by reference. In this representation, each geometric primitive can represented by one or more bit vectors. Each vector represents the path to a quadtree cell (or more generally, binary space partition node), and the union of these cells represent an over approximation of the geometry. These vectors are stored as contiguous arrays, in an order that supports union and intersection in linear time. The degree of approximation can be chosen depending on the number of entities that share the attribute, in order to keep a bound on the overall size of each spatial footprint. This linear bintree representation of spatial footprints is one possible representation. Other representations that afford fast intersection can be chosen by those skilled in the art.

In some embodiments, client computing can request a first level of search engine instances to perform a search. These first level search engine instances can compute the approximate results without referencing the exact RCA index. These approximate results can then be used to localize the query to only a level of detail needed to pick one or more lower-level search engine instances in a hierarchy of servers. A hierarchical structure can also be used to handle a very high query load by having duplicate versions of the servers serving from different computing devices.

In some embodiments, the underlying data can be 3-dimentional, (3D) 4-dimentional (4D) or higher. To incorporate higher dimensions, the generalized location identification system employs binary space partition or similar hierarchical subdivision of space used as a basis for creating the spatial footprint indexes, and fast intersection techniques for 3 and 4 dimensions are readily implementable by those skilled in the art.

In some embodiments the underlying data is not spatial, but rather hierarchical, for example, hierarchically structured information about an organization, its people and its buildings and other resources. Such hierarchical data can be easily embedded into a metric space and followed by the creation of a binary space partition of the data, and therefore incorporated onto the location identification system, which can be used to lookup such data given text or phonetic queries, for example to lookup a person in an organization given some combination of the person's name, designation and building, with possible misspellings.

In some embodiments, for efficiency reasons, the various stages of the mechanism can be done incrementally, with feedback loops. For example, instead of performing fuzzy lookup on all possible terms or sub-sequences in one shot, a few of the more promising terms or sub-sequences can be looked up based on heuristics such as looking for exact matches first. These few matches can then be processed in the later stages of the mechanism, and only if more ranked solutions are desired need additional approximate match records generated. Likewise, search results may be also generated and ranked incrementally.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method performed by a computer system for identifying spatial location information, comprising:
processing spatial information to identify geometric regions, the spatial information including spatial information and associated text;
determining region intersection information identifying spatial relationships between the geometric regions; and
building an index of a region of constant attributes and a second index by analyzing geometric and attribute information from the spatial formation so that a spatial location can be identified based on a received search query.

2. The method of claim 1 further comprising generating a fuzzy text index based on text associated with the spatial information.

3. The method of claim 2 further comprising:
receiving the search query; and
employing the index of the regions of constant attributes and the fuzzy text index to generate search results wherein the search results identify the spatial location.

4. The method of claim 1 wherein the determining further comprises:
employing a computational geometry technique to locate the geometric intersection between geometric regions.

5. The method of claim 1 further comprising generating a spatial index wherein the spatial index correlates the index of the regions of constant attributes with the text associated with the spatial information.

6. The method of claim 1 further comprising:
generating a fuzzy text index based on text associated with the spatial information;
receiving the search query;
employing the index of the regions of constant attributes, a fuzzy text, index and the second index to generate search results wherein the search results identify the spatial location; and
providing the generated search results to a user.

7. The method of claim 6 further comprising employing the fuzzy text index to search for text that is similar to the received search query.

8. The method of claim 6 further comprising including a nearby location that is near a location specified by the received search query.

9. The method of claim 6 further comprising including a nearby location that is near a location specified by the received search query wherein the nearby location is near the specified location when they have intersecting regions.

10. The method of claim 6 further comprising including a nearby location that is near a location specified by the received search query wherein the nearby location is near the specified location when they have intersecting regions of constant attributes.

11. The method of claim 1 further comprising:
generating a fuzzy text index based on text associated with the spatial information;
receiving the search query;
employing the index of the regions of constant attributes and the fuzzy text index to generate search results; and
ranking the generated search results based on a spatially coherent interpretation of the search query.

12. A system for identifying spatial location information, comprising:
a vector database wherein the vector database comprises geometric information including at least (a) spatial information spatially describing items and their locations and (b) textual attributes associated with the items or their locations; and
an index of regions of constant attributes wherein the index associates textual attributes with items and their locations so that a proximity of two locations can be identified.

13. The system of claim 12 further comprising a fuzzy text index wherein the fuzzy text index enables looking up terms in a search query even when the terms contain errors.

14. The system of claim 12 further comprising a fuzzy text index wherein the fuzzy text index enables looking up terms in a search query even when the terms are specified using a script of a different natural language than a natural language of the textual attributes.

15. The system of claim 12 further comprising a search engine component wherein the search engine component employs a fuzzy text index and the index of regions of constant attributes to generate search results in response to a received search query.

16. The system of claim 12 further comprising a cache component that caches spatial information relating to commonly queried items.

17. The system of claim 12 further comprising a sub-sequence analyzer component that identifies terms in a received query with information stored in the index of regions of constant attributes.

18. The system of claim 17 further comprising a result enumerator component that identifies a subset of the identified terms that have common regions of constant attributes to produce a set of search results.

19. A computer-readable medium storing computer-executable instructions that, when executed, perform a method for identifying spatial location information, the method comprising:
receiving a search query wherein the search query is received in a script of a first natural language;
transliterating the received search query into a script of a second natural language to produce a transliterated search query; and
searching in a database of location information based on the transliterated search query.

20. The computer-readable medium of claim 19 wherein the method further comprises splitting the transliterated search query into a set of terms and employing the terms during the searching.
